(19) United States
(12) Patent Application Publication
(10) Pub. No.: US 2014/0041894 A1
(43) Pub. Date: Feb. 13, 2014

(54) EXTENSION WIRE SOCKET ASSEMBLED STRUCTURE HAVING SAFETY SEE-SAW SWITCH DISPOSED FROM INSIDE OUT

(71) Applicant: Ming-Shan Wang, Taoyuan County (TW)

(72) Inventor: Ming-Shan Wang, Taoyuan County (TW)

(21) Appl. No.: 13/572,752

(22) Filed: Aug. 13, 2012

(51) Int. Cl. H01R 13/514

(52) U.S. Cl. 174/53

(57) ABSTRACT

The invention relates to an extension wire socket assembled structure, and more particularly to a safety see-saw switch with an embedded electrical connection device for the extension wire socket having safety see-saw switch disposed from inside out. The present invention is a two-in-one molded structure. An end of a positive output terminal of the safety see-saw switch first rivets the output electrode plate of a socket and another end of the positive output terminal of the safety see-saw switch couples with a dual metal plate within a housing and then a U-shaped body at a front end of an input electrode plate rivets a power cord and a tail end thereof as a positive input terminal is arranged within the housing so that a contact on the positive input terminal connects to a contact of the dual metal plate, forming the embedded electrical connection.

### BACKGROUND OF THE INVENTION

1. Field of the Invention

The invention relates to an extension wire socket assembled structure, and more particularly to a safety see-saw switch with an embedded electrical connection device for the extension wire socket having safety see-saw switch disposed from inside out.

2. Description of the Related Art

With reference to FIGS. 1 through 5, the prior art discloses an extension wire socket 10 comprising an upper casing 11 combined with a lower casing 12, a power cord 13 electrically connected to a plurality of electrode plates 15 through a safety see-saw switch 14 and a plurality of contact holes 16 arranged on a surface thereof for connecting to the electric appliances.

The assembled structure of the extension wire socket 10 as show in FIG. 4 has the safety see-saw switch 14 embedded in the upper casing 11 through a mounted hole 111 and welded each of electrode plates 15 within the socket 10. This kind of assembled structure has following drawbacks:

1. The safety see-saw switch 14 as shown in FIGS. 2 and 3 includes a containing slot 142 within a housing 141 having a button 144, a pulling rod 145, a dual metal plate 146, and a neon light 147. First molding the dual metal plate 146 with an output terminal 14b and arranging an input terminal 14a, the output terminal 14b and a negative terminal 14c in the housing 141, and then closing the housing 141 by a cover body 143; thus, the safety see-saw switch 14 as shown in FIG. 4 cannot be pre-riveted to the electrode plates before being mounted in the mounted hole 111. Further, a connecting line or plate 112 as shown in FIG. 5 is provided for connecting to the safety see-saw switch 14 and the electrode plates by welding. However, the welding method increases more processing procedures and costs. Moreover, it is difficult to ensure the welding quality and is easy to cause the environmental pollution, when using a large number of solder.

2. The conventional power cord 13 is arranged at the same side of the safety see-saw switch 14 so that the power cord 13 is inward connected to the terminal of the switch 14 and the electrode plates 15 by soldering, leading to the same drawback as mentioned above. Therefore, there is room for improvement.

### SUMMARY OF THE INVENTION

It is a primary object of the present invention to provide an extension wire socket assembled structure, which provides a safety see-saw switch with an embedded electrical connection device for the extension wire socket having the safety see-saw switch disposed from inside out, to achieve environmental protection and rapid assembly effects.

In order to achieve the above object, the invention comprises: a socket composed of an upper casing and a lower casing and having at least a first electrode plate and a second electrode plate therein, and at least one of the casing having a plurality of contact holes on a surface thereof; a power cord connected to an end of the socket to provide electrical power for the electrode plates; the safety see-saw switch mounted on an end of the socket and including: a housing having an opening at a side thereof, at least a first containing slot and a second containing slot therein for respectively embedding a positive input terminal and a positive output terminal and a see-saw button on a top surface thereof; a dual metal plate with an auto-trip function arranged under the see-saw button and having a free end connected to the see-saw button and another end connected to the positive output terminal;

wherein the positive output terminal has is convex point first connecting to a tail end of the second electrode plate and then being embedded in the second containing slot by the opening of the housing, and the opening is closed by a cover body, such that the housing and the second electrode plate forms a structure body arranged in the lower casing; the cover body corresponding to the first containing slot has as first groove and the cover body has an embossed U-shaped frame on a surface thereof; and the first electrode plate has an U-shaped body at a front end thereof riveting to the power cord and a tail end of the first electrode plate is integrally molded with the positive input terminal having a vertical surface paralleling to the dual metal plate for the positive input terminal being embedded in the first containing slot of the housing through the first groove of the cover body, and the vertical surface connected to the first electrode plate has a contact electrically connected to the dual metal plate and a horizontal covering surface at a top periphery thereof for embedding in the U-shaped frame;

whereby the safety see-saw switch and the tail end of the second electrode plate first forms a structure body arranged in the lower casing and then the front end of the first electrode plate rivets to the power cord and the tail end of the first electrode plate passes through the first groove of the cover body and is embedded in the first containing slot of the housing to form an electrical connection.

Base on the features disclosed, the socket further includes a third electrode plate therein and the safety see-saw switch further includes a third containing slot arranged in the housing and the cover body corresponding to the third containing slot has a second groove. Moreover, the third electrode plate has an U-shaped body at a front end thereof riveting to the power cord and a tail end of the third electrode plate directly forms a shape of a negative terminal and is embedded in the third containing slot of the housing through the second groove of the cover body and the third electrode plate has a slot arranged at a bottom periphery thereof for lodging in the housing.

Further, the U-shaped frame of the cover body has a lug at middle thereof and the covering surface of the first electrode plate corresponding to the lug has a positioning hole for the covering surface lodging in the U-shaped frame.

Therefore, instead of the conventional vertical switch terminal soldering with the power cord, the present invention without solder has environmental protection and rapid assembly effects.

### BRIEF DESCRIPTION OF THE DRAWINGS

FIG. 1 is a schematic view of the conventional extension wire socket structure;

FIG. 2 is a perspective view of an appearance of the conventional safety see-saw switch;

FIG. 3 is a sectional view of the conventional safety see-saw switch;

FIG. 4 is an exploded perspective view of the conventional extension wire socket;

FIG. 5 is an exploded schematic view of part of the conventional extension wire socket;

FIGS. 6A, 6B, 6C are schematic views of the assembled process of the safety see-saw switch in accordance with the present invention;

FIG. 7 is an exploded perspective view of the safety see-saw switch and electrode plates in accordance with the present invention;

FIG. 8 is a perspective view of a structure body composed of the safety see-saw switch and a second electrode plate in accordance with the present invention;

FIG. 9 is an exploded perspective view of the preferred embodiment in accordance with the present invention;

FIG. 10 is an exploded schematic view of part of the preferred embodiment in accordance with the present invention;

FIG. 11 is a perspective view of an appearance of the preferred embodiment in accordance with the present invention; and

FIG. 12 is a perspective view form another angle of the preferred embodiment in accordance with the present invention.

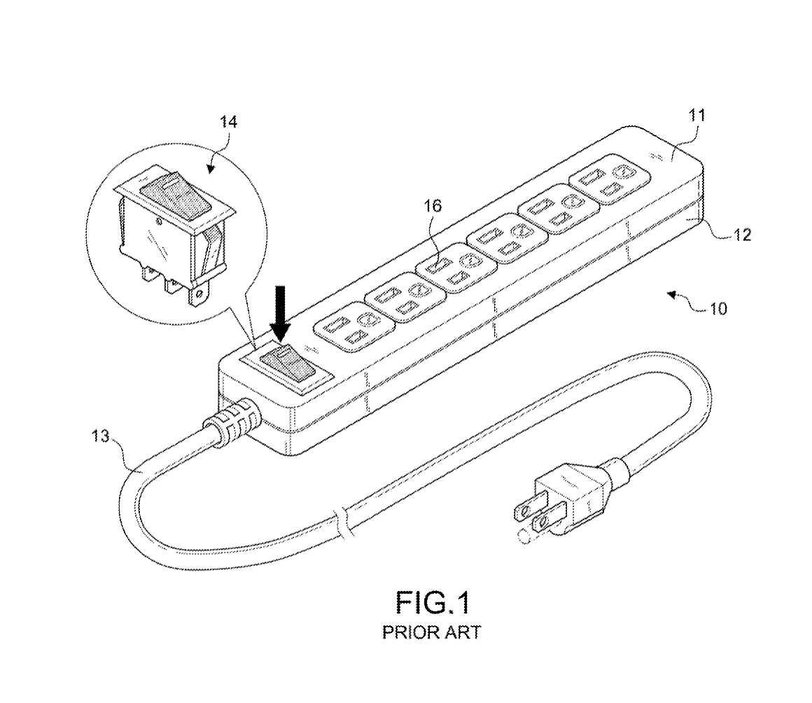

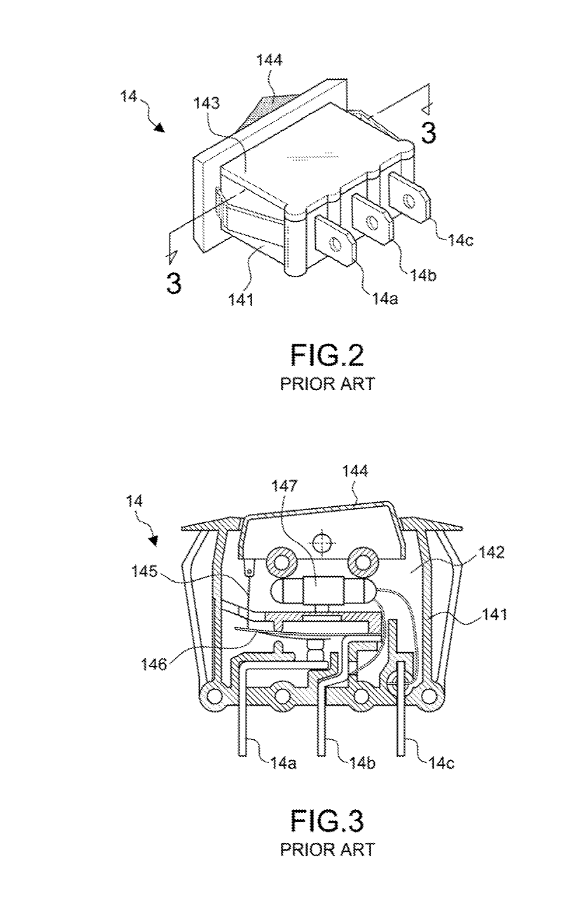

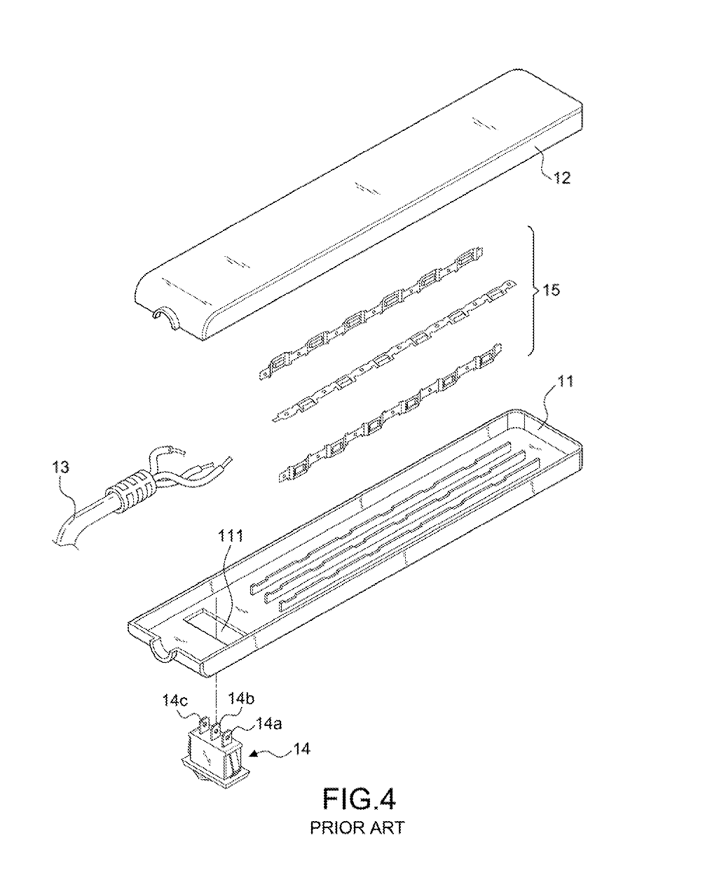

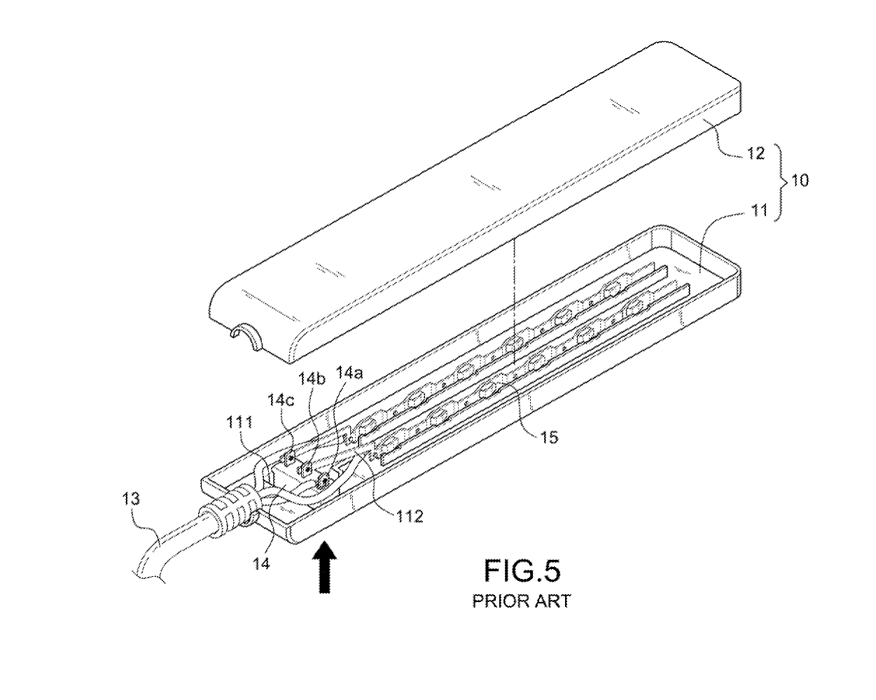

### DETAILED DESCRIPTION OF THE PREFERRED EMBODIMENT

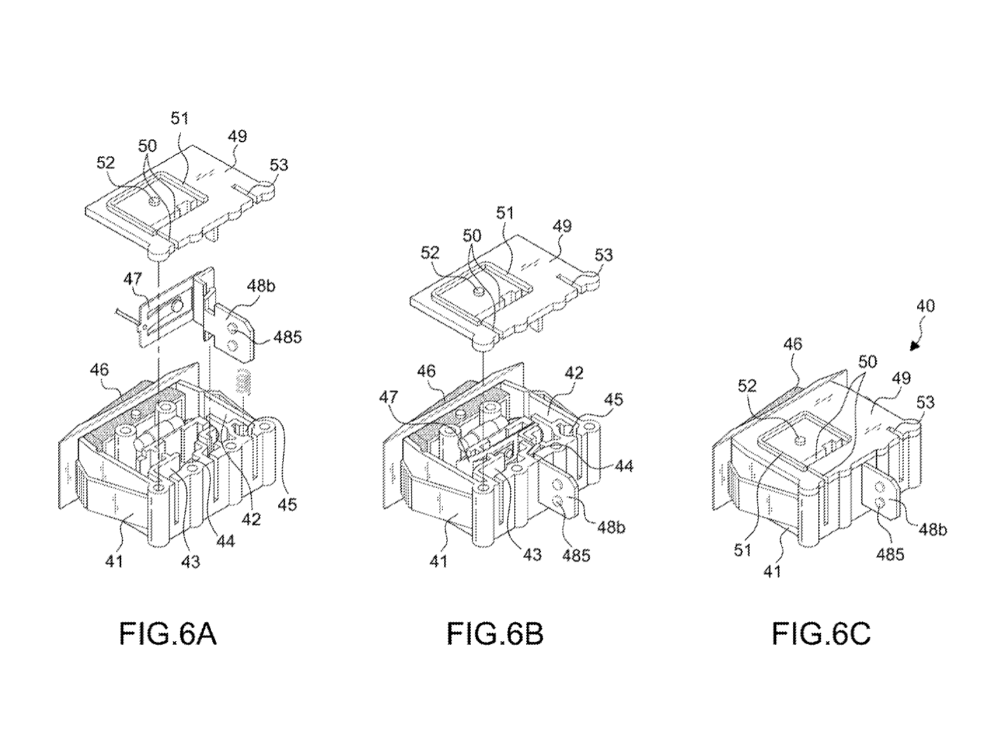

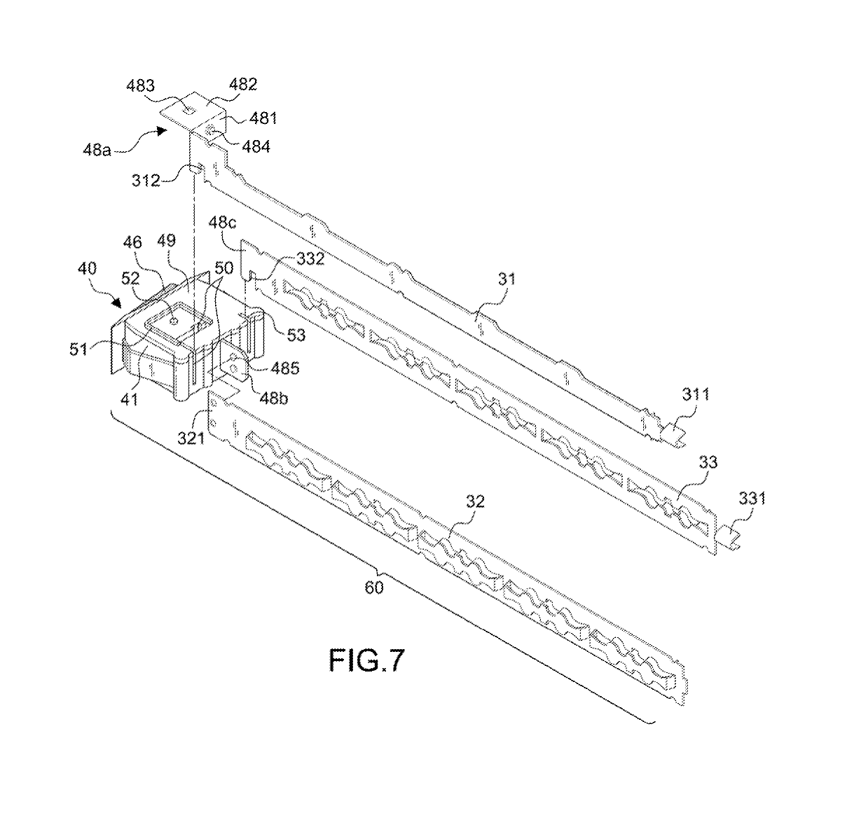

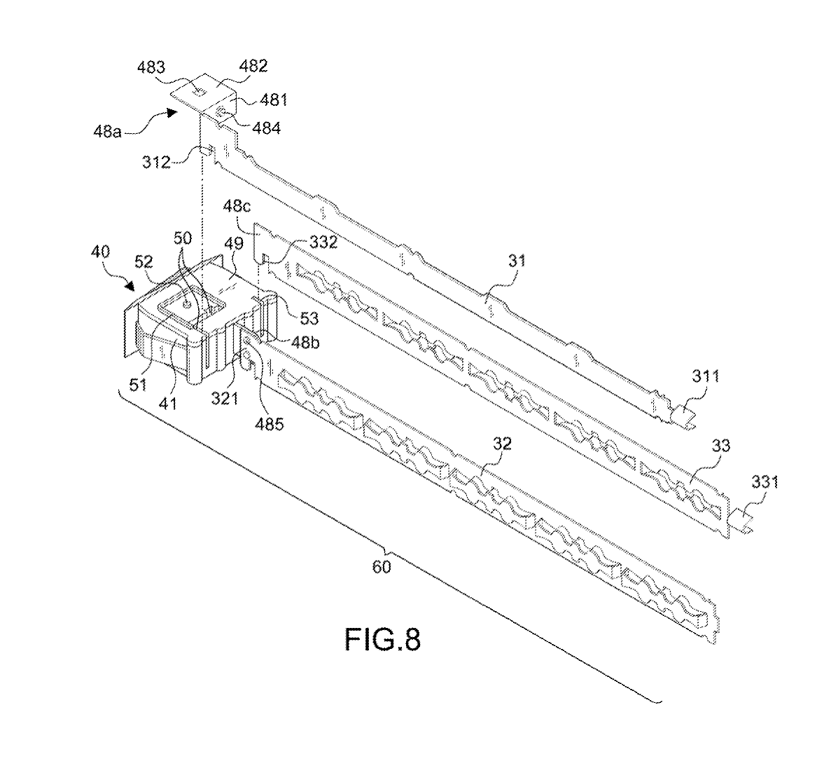

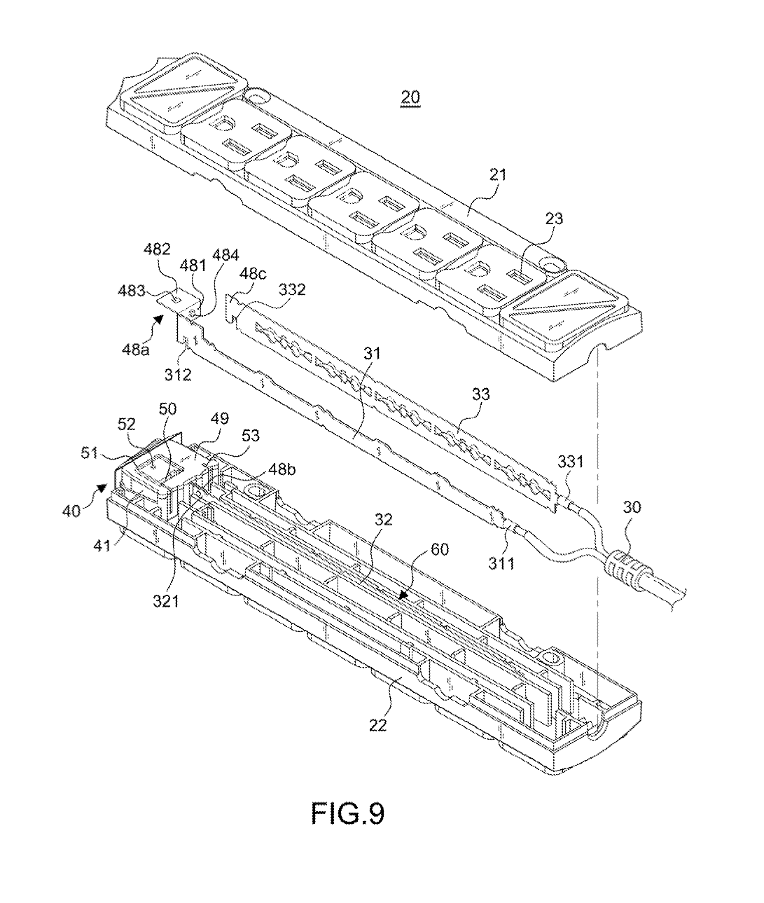

FIGS. 6A to 6C show the molding process of a safety see-saw switch 40 of the present invention and FIG. 7 is a schematic view, showing the combination of a positive output terminal 48b of the safety see-saw switch 40 and a second electrode plate 32. The difference between the present invention and a conventional socket assembled structure is that the present invention provides the salty see-saw switch 40 first coupled with the second electrode plate 32 to form a semi-structure 60 as shown in FIG. 8, and then being embedded in a lower casing 22 as shown in FIG. 9; at last, a first electrode plate 31 or even a third electrode plate 33 is embedded in the lower casing 22 to provide an integral structure of a safety extension wire socket without any welding point and achieve the purpose of rapid assembly and energy-efficient environmental protection.

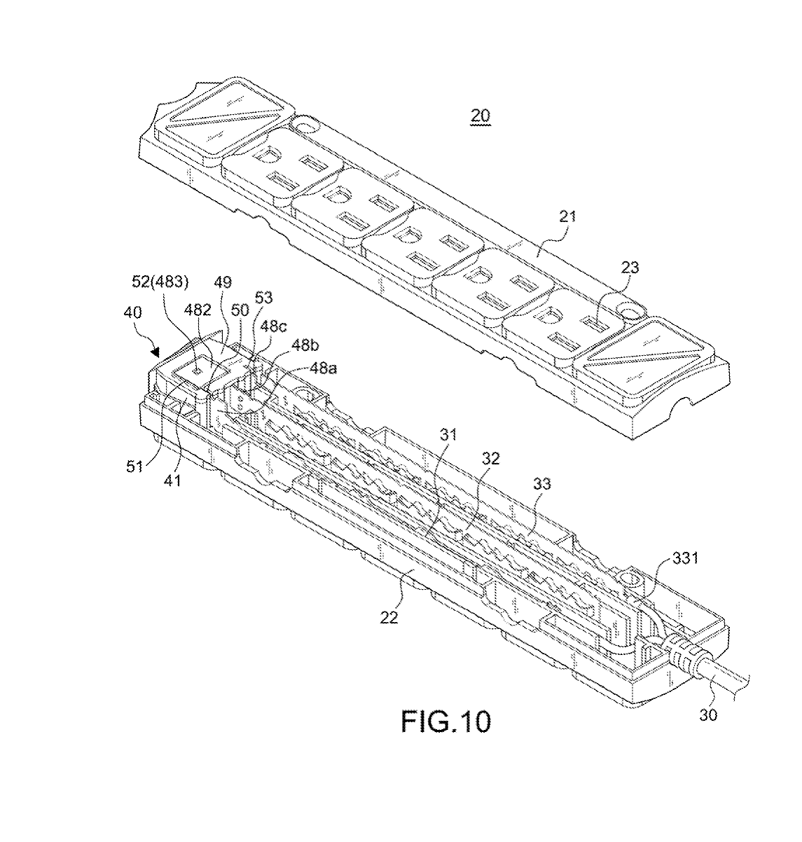

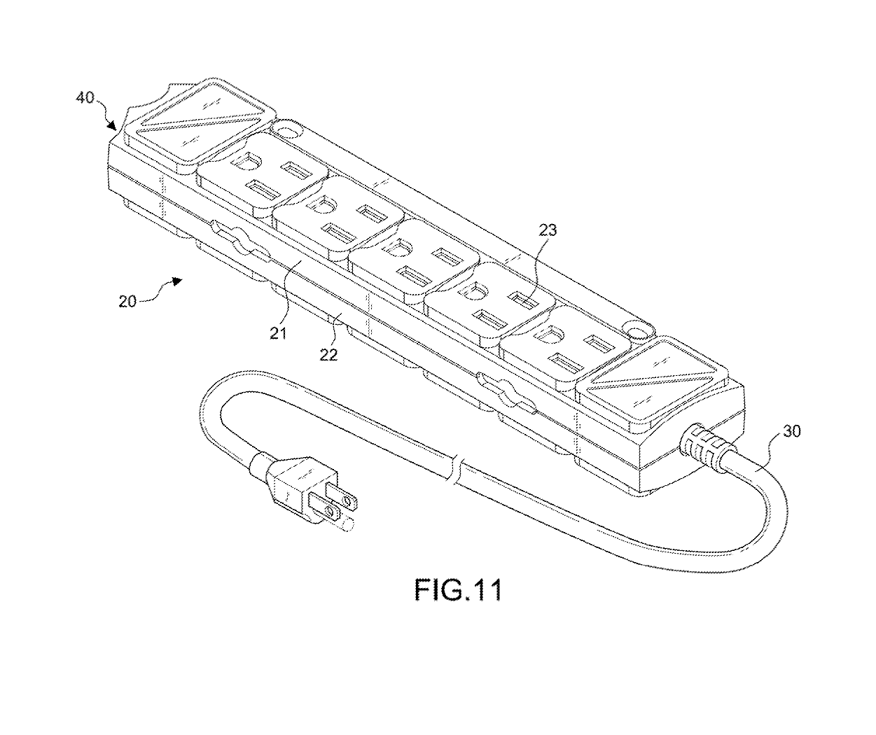

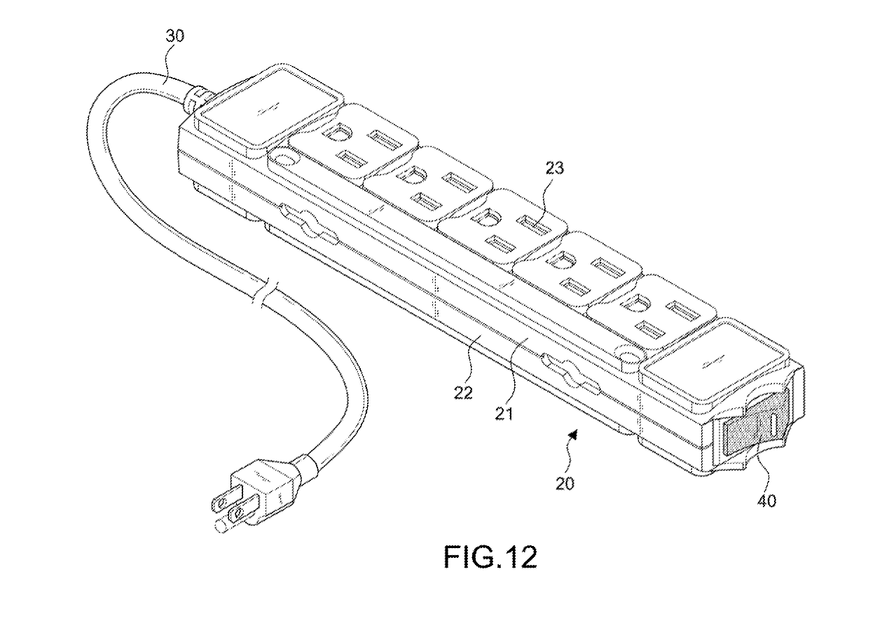

Referring to FIGS. 6A through 12, the preferred embodiment of an extension wire socket assembled structure having the safety see-saw switch disposed from inside out in accordance with the present invention comprises: a socket 20 composed of an upper casing 21 and the lower casing 22 and having at least the first electrode plate 31 and the second electrode plate 32 therein, and at least one of the casing 21 having a plurality of contact holes 23 on a surface thereof; a power cord 30 connected to an end of the socket 20 to provide electrical power for the electrode plates 31, 32; the safety see-saw switch 40 mounted on an end of the socket 20 and including: a housing 41 having an opening 42 at a side thereof, at least a first containing slot 43 and a second containing slot 44 therein for respectively embedding a positive input terminal 48a and the positive output terminal 48b, and a see-saw button 46 on a top surface thereof; a dual metal plate 47 with an auto-trip function arranged under the see-saw button 46 and having a free end connected to the see-saw button 46 and another end connected to the positive output terminal 48b. However, the features disclosed are prior art, illustrating in the U.S. Pat. Nos. 6,400,250, 5,694,106, and 6,462,292 and thus will not be described in details here.

The present invention has the main features wherein the positive output terminal 48b has a convex point 485 first connecting to a tail end 321 of the second electrode plate 32 and then being embedded in the second containing slot 44 through the opening 42 of the housing 41; at last, the opening 42 is closed by a cover body 49, such that the housing 41 and the second electrode plate 32 together form a structure body 60 as a semi-product arranged in the lower casing 22. The cover body 49 corresponding to the first containing slot 43 has a first groove 50 and the cover body 49 has an embossed U-shaped frame 51 on a surface thereof. Moreover, the U-shaped frame 51 of the cover body 49 has a lug 52 at middle thereof. In this embodiment, the lug 52 is in a cylindrical shape but it is not a limitation; that is, the lug 52 may be in a rectangular or multilateral shape.

The first electrode plate 31 has an U-shaped body 311 at a front end thereof riveting to the power cord 30 and a tail end of the first electrode plate 31 is integrally molded with the positive input terminal 48a having a vertical surface 481 paralleling to the dual metal plate 47 for the positive input terminal 48a being embedded in the first containing slot 43 of the housing 41 through the first groove 50 of the cover body 49, and the first electrode plate 31 closing to a bottom periphery of the vertical surface 481 has a slot 312. The vertical surface 481 connected to the first electrode plate 31 has a contact 484 electrically connected to the dual metal plate 47 and a horizontal covering surface 482 at a top periphery thereof. Moreover, the covering surface 482 of the first electrode plate 31 corresponding to the lug 52 has a positioning hole 483 for the covering surface 482 lodging in the U-shaped frame 51. In this embodiment, the positioning hole 483 is a square hole but it is not a limitation. The positioning hole may be any shapes which can be coupled with the lug 52. Further, the first containing slot 43 of the safety see-saw switch 40 and the first groove 50 of the cover body 49 both form an L-shaped body and the vertical surface 481 of the positive input terminal 48a is perpendicular to the first electrode plate 31 to form an L-shaped body being embedded in the first containing slot 43 through the first groove 50.

In this embodiment, the socket 20 further includes a third electrode plate 31 therein and the safety see-saw switch 40 further includes a third containing slot 45 arranged in the housing 41 and the cover body 49 corresponding to the third containing slot 45 has a second groove 53. The third electrode plate 33 has an U-shaped body 311 at a front end thereof riveting to the power cord 30 and a tail end of the third electrode plate 33 directly forms a shape of a negative terminal 48c and is embedded in the third containing slot 45 of the housing 41 through the second groove 53 of the cover body 49 and the third electrode plate 33 has a slot arranged at a bottom periphery thereof for lodging in the housing 41.

Whereby the safety see-saw switch 40 and the tail end 321 of the second electrode plate 32 first forms the structure body 60 arranged in the lower casing 22 and the U-shaped bodies 311, 331 at the front end of the first electrode plate 31 and the third electrode plate 32 rivets to the power cord 30 and then the tail ends of the first electrode plate 31 and the third electrode plate 32 respectively pass through the first groove 50 and the second groove 51 and are embedded in the first containing slot 43 and the third containing slot 45 of the housing 41; at last, the covering surface 482 covers in the U-shaped frame 51 to form a positioning and anti-trap wall construction.

Moreover, the present invention provides the U-shaped frame 51 around the first groove 50 to prevent the exposed flame generated by the internal electrical contact and to position the covering surface 482; such that, the structure of the present invention is integrated and stable.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An extension wire socket assembled structure having safety see-saw switch disposed from inside out, particularly to the safety see-saw switch with an embedded electrical connection device, comprising:
a socket composed of an upper casing and a lower casing and having at least a first electrode plate and a second electrode plate therein, and at least one of the casing having a plurality of contact holes on a surface thereof;
a power cord connected to an end of the socket to provide electrical power for the electrode plates;
a safety see-saw switch mounted on an end of the socket and including: a housing having an opening at a side thereof, at least a first containing slot and a second containing slot therein for respectively embedding a positive input terminal and a positive output terminal and a see-saw button on a top surface thereof; a dual metal plate with an auto-trip function arranged under the see-saw button and having a free end connected to the see-saw button and another end connected to the positive output terminal;
wherein the positive output terminal has a convex point first connecting to a tail end of the second electrode plate and then being embedded in the second containing slot through the opening of the housing and the opening is closed by a cover body; such that, the housing and the second electrode plate forms a structure body arranged in the lower casing; the cover body corresponding to the first containing slot has a first groove and the cover body has an embossed U-shaped frame on a surface thereof; and
the first electrode plate has an U-shaped body at a front end thereof riveting to the power cord and a tail end of the first electrode plate is integrally molded with the positive input terminal having a vertical surface paralleling to the dual metal plate for the positive input terminal being embedded in the first containing slot of the housing through the first groove of the cover body, and the vertical surface connected to the first electrode plate has a contact electrically connected to the dual metal plate and a horizontal covering surface at a top periphery thereof for embedding in the U-shaped frame;
whereby the safety see-saw switch and the tail end of the second electrode plate first forms a structure body arranged in the lower casing and then the front end of the first electrode plate rivets to the power cord and the tail end of the first electrode plate passes through the first groove of the cover body and is embedded in the first containing slot of the housing to form an electrical connection.

2. The extension wire socket assembled structure having safety see-saw switch disposed from inside out as claimed in claim 1, wherein the socket further includes a third electrode plate therein and the safety see-saw switch further includes a third containing slot arranged in the housing and the cover body corresponding to the third containing slot has a second groove; the third electrode plate has an U-shaped body at a front end thereof riveting to the power cord and a tail end of the third electrode plate directly forms a shape of a negative terminal and is embedded in the third containing slot of the housing through the second groove of the cover body and the third electrode plate has a slot arranged at a bottom periphery thereof for lodging in the housing.

3. The extension wire socket assembled structure having safety see-saw switch disposed from inside out as claimed in claim 2, wherein the U-shaped frame of the cover body has a lug at a middle thereof and the covering surface of the first electrode plate corresponding to the lug has a positioning hole for the covering surface lodging in the U-shaped frame.

4. The extension wire socket assembled structure having safety see-saw switch disposed from inside out as claimed in claim 3, wherein the first containing slot of the safety see-saw switch and the first groove of the cover body both form an L-shaped body.

5. The extension wire socket assembled structure having safety see-saw switch disposed from inside out as claimed in claim 4, wherein the vertical surface of the positive input terminal is perpendicular to the first electrode plate to form an L-shaped body being embedded in the first containing slot through the first groove.
